(19) United States
(12) Patent Application Publication
(10) Pub. No.: US 2003/0068064 A1
(43) Pub. Date: Apr. 10, 2003

(54) Neoprene surround for an electro-dynamic acoustical transducer

(76) Inventor: Eugene J. Czerwinski, Simi Valley, CA (US)

Correspondence Address: W. Edward Johansen, 11661 San Vicente Boulevard, Los Angeles, CA, 90049, US

(21) Appl. No.: 09/973,472

(22) Filed: Oct. 9, 2001

(51) Int. Cl. H04R 1/00; H04R 9/06; H04R 11/02

(52) U.S. Cl. 381/398

(57) ABSTRACT

A surround is for use in an electron-dynamic acoustical transducer. The electron-dynamic acoustical transducer includes a frame, a diaphragm and a voice coil. The surround includes a single, large, semi-circular corrugation that is constructed from compressed neoprene foam rubber and secured to the frame by the surround. The surround has a plurality of radially distributed, relatively less-compressed areas.

### BACKGROUND OF THE INVENTION

The present invention relates generally to the field of loudspeakers and more particularly to piston suspension assemblies for small electro-dynamic acoustical transducers utilizing a single piece of resilient neoprene material for the sound radiating dome and the piston suspension.

The suspension system in any loudspeaker is normally comprised of two elements, the surround (front or outer suspension) and the spider (rear suspension). The surround is the mechanical device and holds the outer edge of the diaphragm/cone of the loudspeaker. Often the word “roll” is used in place of “surround” when describing the front suspension. Surrounds can be constructed from several materials including rubber, compressed foam rubber (neoprene), corrugated cloth, paper and plastic. Roll surrounds have a single, large, semi-circular corrugation typically constructed from rubber, compressed foam rubber or treated fabric.

Surrounds help keep the cone centered and provide a portion of the restoring force that keeps the voice coil in the gap created between the pole piece and top plate of the loudspeaker. The surround also provides a damped termination for the edge of the cone. The choice of thickness and material type for surround construction can greatly alter the response of the loudspeaker. The spider, commonly constructed from treated corrugated fabric, also keeps the voice coil concentric to the pole piece, as well as providing a portion of the restoring force that maintains the voice coil within the gap. The stiffness of the spider can greatly affect the loudspeaker's resonance. The spider also provides a barrier for keeping foreign particles away from the gap area.

Surrounds are one of the primary-limiting factors in designing long-excursion loudspeakers. Excursion is defined as the amount of linear length the cone body can travel. With the conventional small roll diameters currently in use, the excursion is often limited by the surround's physical limits. Larger surrounds cannot be used without an attendant loss in effective cone area for a loudspeaker of given outside diameter, thus, creating an inevitable trade-off. Excursion and cone-area are the two factors which contribute to a loudspeaker's volume displacement. The higher the volume displacement capability of a loudspeaker, the greater the ultimate low frequency output potential of the loudspeaker can be. In addition to controlling the linear motion of the cone, the surround also acts as a major centering force for the loudspeaker's voice coil. This centering force prevents the voice coil and former from rocking and rubbing against the pole piece or top plate.

The surround is typically glued to the inner top edge of a flat extension or rim on the outside of the frame of the loudspeaker. The frame also acts as the mounting flange of the loudspeaker. A significant amount of cone-area is sacrificed, relative to the loudspeaker's overall footprint (outside diameter). The cone-area is a major contributing factor to a loudspeaker's output and efficiency. The sacrifice in cone-area is seen as a necessary evil because of the need to provide an accessible mounting flange for the loudspeaker.

Current methods for replacing moving parts of a cone loudspeaker, for the purpose of repair, require special skill, tools and adhesives. Typically, the moving parts are cut away and the loudspeaker frame and motor structure (magnet and metal parts that complete the magnetic circuit) are stripped down with chemicals or hand scraped to remove adhesive residue. Once the frame is stripped, new moving parts must be glued together, aligned carefully and glued to the loudspeaker frame. This repair or replacement assembly process normally is handled by trained loudspeaker technicians and requires specialized gauges or alignment spacers for each loudspeaker, as well as a high degree of precision in order to be successful. Some current small dome loudspeakers, primarily tweeters, and compression drivers feature the ability to quickly remove and replace their moving parts. This is facilitated greatly in these designs due to the lack of a rear suspension or spider. In these designs, the diaphragm, voice-coil and surround are typically attached to a rigid frame that bolts or screws to the top plate of the loudspeaker. The frame is usually located with holes that line up to pegs on the motor structure for alignment. In such designs, the loudspeaker must be removed from its mounting location to perform the repair. One product currently on the market provides a woofer in which the motor structure (i.e. magnet, back plate, pole piece and top plate) is removed from the frame so that the voice coil can be inspected. However, the moving parts (roll, cone body, dust cap, voice coil and spider) remain attached to the loudspeaker's frame. Another product on the market provides a cone loudspeaker that features a screw-down spacer between its dual spiders or rear suspensions. The spacer screws through the frame to the top plate of the loudspeaker. The screws do not provide the necessary physical constraints to align the voice coil within the magnetic gap. This is still done with gauges (alignment spacers). The surround is glued to the frame in a conventional manner and the spider is glued to the spacer. This product fails to provide for easy field replacement of its parts. A loudspeaker must be carefully optimized for its intended task. Changes in its moving mass, motor strength, voice coil winding length/gauge/thickness or suspension compliance radically affect the performance of the loudspeaker. There are inevitable tradeoffs in the process of loudspeaker design. These tradeoffs must be carefully balanced with the intended task of the loudspeaker in mind, concert sound reinforcement, automotive sub-bass, a home-theater. With woofers, the intended enclosure type affects the design of the driver as well. An end user chooses a loudspeaker that works best in his intended application. The most expensive components of a loudspeaker are its non-moving parts, which generally include the loudspeaker frame and the motor structure. The moving parts of the loudspeaker generally represent a smaller portion of the total cost of the loudspeaker. If the user's operating conditions change, the loudspeaker may no longer be well-suited and is likely to be replaced with a more appropriate loudspeaker. Such is the case even if there is nothing wrong with the original loudspeaker and usually amounts to a relatively significant expenditure each time the operating conditions change. Some existing small dome loudspeakers, primarily tweeters, and compression drivers feature the ability to remove and replace their moving parts, in the event of failure. Different impedance diaphragms are offered that will work in the same motor structure. The basic mission of the loudspeaker is not changed, only the load presented to the amplifier. However, the prior art fails to provide for reconfiguring the same motor structure in the field for different applications and enclosure types, specifically for low frequency woofers. Additionally, the prior art fails to provide for a loudspeaker design that provides for relatively quick field replacement of the moving parts of a cone type loudspeaker, and in more particular to cone type loudspeakers which feature a rear suspension or spider in addition to the surround. The prior art also fails to provide a surround that is attached to the outer edge of the loudspeaker frame for improved overall displacement capability. Furthermore, the prior art fails to provide for a removable surround. It is therefore, to the effective resolution of the aforementioned problems and shortcomings of the prior art that the present invention is directed.

U.S. Pat. No. 4,433,214 teaches an electro-dynamic acoustic transducer with a slotted piston suspension system. Use of the slotted piston suspension results in greater linear excursions by relieving stresses within the diaphragm during the movement and allows operation of a transducer with greater magnet size and greater radiating areas of diaphragm suspension thereby improving overall efficiency of the transducer. The slotted piston suspension can be utilized with electro-dynamic acoustic transducers operating in the range of 200 to 20,000 cycles per second.

The piston suspension assemblies of many different shapes have been devised for use in cone displacement electro-dynamic acoustical transducers containing permanent magnets in order to provide the electromagnetic fields required for operation. Small acoustical transducers are inexpensive and are typically found in portable two-way radio communications devices or personal electronic radio receiving apparatus. In order to allow adequate expansion of the sound-radiating dome, which will result in improved linear excursions during operation, small electro-dynamic acoustic transducers require much larger piston suspensions than exist today. The piston suspension assemblies are often fraught with many different types of stresses that occur at different positions within the plane of the sound radiating dome and piston suspension during cone displacement. One such stress is a “bending” stress that occurs along the circumference of the sound radiating dome at the junction of the piston suspension. A second stress is found stretching along a plane, perpendicular to the radii of the piston suspension, in the sound-radiating dome. During operation, these stresses result in continued wear and tear of the piston suspension and sound-radiating dome, thereby causing a decrease in the performance of the transducer in its ability to produce linear excursions during operation. This will result in the acoustical transducer becoming less and less effective as operation continues over a period of time.

The piston suspensions often utilize arcuate slots contained within a flat (not curved) piston suspension. Generally, these slots, while relieving some of the stresses discussed above, create “bending” type stresses elsewhere in the piston suspension (i.e. in the material between the slots) and concentric “stretching” type stresses within the arcuate slots of the flat suspensions, which occur by the twisting motion of the sound radiating dome or cone during its displacement. The piston suspensions of acoustical transducers are generally made from any varied materials and from a material different from that which the sound-radiating dome is made. The resiliency of such materials is varied, which affects the linearity of the resulting excursions. This difference in material will introduce an additional cost in the manufacturing of the end product. The sound-radiating dome of an acoustical transducer is smaller in size for a given linear excursion, than the sound-radiating dome associated with the piston suspension. The piston suspension assembly for an electro-dynamic acoustical transducer will result in increased efficiency and improved audio quality. The acoustical transducer piston suspension assembly produces linear excursions corresponding to much larger piston suspension assemblies that exist in larger electro-dynamic transducers, thus allowing the surface area of the sound radiating dome and the size of the magnet to be increased, which will improve the efficiency of the transducer. The piston suspension assembly for a small acoustical transducer has a center sound radiating dome of which at least 80% of the total surface area of the suspension and dome thereby allowing the use of magnets which are physically larger in size than those presently used in the same-sized electro-dynamic transducers. An electro-dynamic transducer has a piston suspension assembly made of a resilient plastic film to allow the surface area of the piston suspension to be sharply curved. A sound radiating dome and piston suspension assembly has been fabricated from a unified piece of resilient plastic film, which simplifies production and reduces costs.

A small electro-dynamic acoustical transducer includes a piston suspension assembly which is sharply curved around the circumference of the center-positioned sound radiating dome and has elongated stress relieving slots integral to the surface thereof, such piston suspension being made from a resilient, flexible plastic film. An increase in the size of the over-all piston suspension will result in a proportional increase in the linear excursions of the sound-radiating dome, thereby increasing the overall performance of the transducer during operation. For the same required excursion produced by existing electro-dynamic acoustical transducers in the prior art, the piston suspension of the present invention can be made smaller in size. In this manner, the radiating area and magnet size of the electro-dynamic transducer can be maximized which will improve the operating efficiency of the transducer. The piston suspension assembly is for use with an associated electro-dynamic acoustical transducer.

The slotted piston suspension assembly includes a curved centered sound radiating dome and a curved piston suspension manufactured from the same single piece of resilient flexible plastic material. Similar materials, which can be sharply curved, may also be used. The curved piston suspension further includes stress-relieving elongated slots integral therein. The slots are positioned at predetermined intervals along the circumference of the upper surface of the piston suspension. The elongated slots have a predetermined reduced thickness relative to the thickness of the material of the surrounding piston suspension thereby preventing air that is activated in front of the sound-radiating dome from moving to the back sonic area which would normally result in sound cancellation. The slotted piston suspension assembly causes the simultaneous relief of certain bending stresses experienced along the radii of the sound radiating dome, as well as certain perpendicular concentric stresses, in such a manner as to enhance the overall effectiveness and the overall efficiency of the transducer. The slotted piston suspension is designed for use in the range of 200 to 20,000 cycles per second and has been tested and found to be highly satisfactory in use. Other piston suspensions for acoustical transducers customarily found create a number of different types of stresses during their cone displacement. One such stress is the “bending” stress along the radii of the suspension. Another stress, which is created during operation, is a “stretching” stress that is perpendicular to the radii of the suspension in the plane of the sound-radiating dome. There will exist certain concentric stretching stresses in the strips between the slots. Concentric arcuate slots in the plane of a flat cone are introduced. These slots will relieve bending stresses along the radii of the piston suspension, they will create bending stresses in the strips between the slots and create other concentric stretching stresses when the sound radiating dome twists during resulting displacement. This twisting motion is nonlinear and undesirable.

U.S. Pat. No. 5,949,898 teaches a surround for a loudspeaker assembly. The outside edge of the surround is attached to the outer edge of the frame of the loudspeaker via a permanent or removable means. When removably attached, access to the mounting holes of the frame of the loudspeaker is accomplished by moving the roll to one side, prior to the attachment of the securing means. The method of attachment may include either the use of an annular o-ring or the use of a locking finger.

U.S. Pat. No. 5,734,734 teaches a voice coil adaptor ring and loudspeaker system of the moving coil type. The loudspeaker system includes a cone diaphragm supported by a frame, a voice coil former for supporting a voice coil, and a lower suspension for securing and centering the voice coil former in a magnetic gap while it is displaced by a magnetic circuit. The voice coil adaptor ring is mounted over the voice coil former and includes a substantially cylindrical sleeve which has a ledge extending outward from the sleeve for supporting the cone and lower suspension. An inner glue flange projects inward from the sleeve so as to define a diameter corresponding to an outer diameter of the voice coil former. The sleeve, the inner glue flange and the voice coil former define a gap for receiving epoxies. A plurality of venting passages are in fluid communication with a cap volume defined by the cone and a dust cap for venting hot air from the cap volume.

U.S. Pat. No. 6,224,801 teaches a method of making a speaker that includes providing a pair of dies. The dies between them define a cavity. A first portion of the cavity receives a diaphragm of the speaker. A second portion of the cavity adjacent an outer perimeter of the diaphragm receives a fluid thermoplastic elastomer for forming a diaphragm surround. The second portion includes a perimetrally inner first region adjacent the outer perimeter of the diaphragm for receiving the thermoplastic elastomer to form a perimetrally inner flange for bonding to the diaphragm adjacent the outer perimeter of the diaphragm. The second portion includes a central second region for receiving the thermoplastic elastomer to form a connecting arch of the surround. The second portion also includes a perimetrally outer third region for receiving the thermoplastic elastomer to form a perimetrally outer flange for attachment to a diaphragm support. A diaphragm is placed between the dies. The dies are closed. An amount of the fluid thermoplastic elastomer sufficient to fill the second portion is introduced into the cavity, and is permitted to solidify. This invention relates to transducers and particularly to a method of making a loudspeaker and a loudspeaker made by the method.

Loudspeakers incorporating molded components are known. There are, for example, the loudspeakers illustrated and described in U.S. Pat. Nos. 3,997,023 and 5,319,718.

U.S. Pat. No. 3,997,023 employs an injection-molded surround attached to the speaker frame and diaphragm by suitable adhesives. In U.S. Pat. No. 5,319,718 a diaphragm is provided with a closed-cell polyurethane foam surround by placing the diaphragm in a mold, depositing uncured foamable urethane around the perimeter of the diaphragm, closing the mold and permitting the foamable urethane to foam and cure in a cavity formed by the mold around the perimeter of the diaphragm. The urethane impregnates the exposed outer peripheral edge of the diaphragm, bonding it to the diaphragm, and forms a closed cell outer skin as it cures.

A method of making a speaker includes providing a pair of dies that define between them a cavity. A first portion of the cavity is for receiving a diaphragm of the speaker. A second portion of the cavity adjacent an outer perimeter of the diaphragm when it is placed in the cavity receives a fluid thermoplastic elastomer for forming a diaphragm surround. The second portion includes a perimetrally inner first region adjacent the outer perimeter of the diaphragm for receiving the thermoplastic elastomer to form a perimetrally inner flange for bonding to the diaphragm adjacent the outer perimeter of the diaphragm when the fluid thermoplastic elastomer is introduced into the cavity. The second portion includes a central second region for receiving the thermoplastic elastomer to form a connecting arch of the surround when the fluid thermoplastic elastomer is introduced into the cavity.

The second portion also includes a perimetrally outer third region for receiving the thermoplastic elastomer to form a perimetrally outer flange for attachment to a diaphragm support when the fluid thermoplastic elastomer is introduced into the cavity. A diaphragm is placed between the dies. The dies are closed. An amount of the fluid thermoplastic elastomer sufficient to fill the second portion is introduced into the cavity, and is permitted to solidify.

U.S. Pat. No. 6,219,432 teaches a loudspeaker drive unit. The driver unit includes a diaphragm, a chassis member and a surround connecting the outer portion of the diaphragm to the chassis member in which substantially all parts of the surround located between the diaphragm and the chassis member and capable of radiating sound are arranged parallel or at an acute angle with respect to the longitudinal axis of the loudspeaker drive unit, or the surround is made of a body of foam material arranged to be compressed against the chassis member when the diaphragm moves towards the chassis member, or the bending wave impedance of the surround is matched to the bending wave impedance of the diaphragm.

Known loudspeaker drive units include a diaphragm of which the outer portion is connected to a chassis member by way of a flexible surround.

U.S. Pat. No. 6,118,884 teaches a loudspeaker system of the moving coil type which includes a cone diaphragm supported by a frame, a voice coil former for supporting a voice coil, a lower suspension for securing and centering the voice coil former in a magnetic gap while it is displaced by a magnetic circuit and a voice coil adaptor ring. The voice coil adaptor ring is mounted over the voice coil former and includes a substantially cylindrical sleeve having at least one ledge extending outward from said sleeve for supporting the cone and lower suspension and a plurality of venting passages in fluid communication with a cone volume defined by the cone for venting hot air from the cone volume.

U.S. Pat. No. 5,111,510 teaches a speaker which includes a diaphragm integrally combined with a first frame piece and a driver unit integrally combined with a second frame piece.

U.S. Pat. No. 5,371,805 teaches a speaker which employs a diaphragm secured to a first periphery of an edge member and a frame secured to a second periphery of the edge member.

U.S. Pat. No. 5,323,469 teaches a conical loudspeaker which has a conical stabilizing element joined between an underside of a speaker membrane and an outside surface of a speaker moving coil carrier.

U.S. Pat. No. 5,424,496 teaches an electromagnetic converter. The converter includes an internal magnet system, a moving coil and tubular segment.

U.S. Pat. No. 4,764,968 teaches a disk-like diaphragm made from a conical plastic film and provided with vacuum formed support members which extend up to the disk-like radiating layer.

U.S. Pat. No. 4,118,605 teaches a coil mount structure which includes a cylindrical member, around one end portion of which a diaphragm edge is fixed, an inner peripheral edge portion where a damper is removably fixed, and an opposite end portion around which a coil is provided. Kobayashi does not provide any structure for ventilating air pressure from beneath the dust cap or a structure for creating a secure joint between the diaphragm/cone, spider, and/or voice coil. The structure of an adaptor-ring facilitates a stronger adhesive joint between the cone, spider, a voice coil bobbin and a means for venting air pressure buildup. There remains a need for a loudspeaker capable of providing improved structural joints between the speaker cone, spider, and voice coil former, allowing the use of smaller voice coil systems and providing ventilation in the speaker without forfeiting performance.

An acoustical piston suspension includes the curvature of a resilient sound radiating dome and the uniform recurring elongated stress relieving slots in the outer circumference of the upper surface of the curved piston suspension. This piston suspension assembly is manufactured from a single piece of resilient plastic material or from materials of similar resiliency. A reinforcing plastic film may be permanently affixed to the sound radiating dome to provide the necessary rigidity required for greater linear excursions in the radiating area and overall optimum effectiveness. The elongated stress-relieving slots are specifically designed to relieve those stresses created which are perpendicular to the radii of the suspension (along the concentric circles). This will leave only the bending-type stresses remaining, which lie along the radii of the suspension in the material between the slots. To enhance the resiliency and responsiveness of the piston suspension during operation, the reinforcing plastic film does not interfere with the curved piston suspension, i.e. elongated stress-relieving slots and the resilient material between the elongated slots. A single piece of resilient plastic material is utilized to make the curved sound radiating dome and the curved piston suspension structure in the improved acoustical transducer. The residual material within the elongated stress-relieving slots, which are incorporated in the outer circumference of the upper surface of the piston suspension, will prevent the activated air from moving from the front of the diaphragm to the rear of the sonic area that would result in sound cancellation. This material within the elongated stress-relieving slots has a predetermined thickness that is less than the thickness of the surrounding material of the curved piston suspension assembly.

The inventor hereby incorporates the above patents by reference.

### SUMMARY OF THE INVENTION

The present invention is directed to an electron-dynamic acoustical transducer. The transducer includes a frame, a diaphragm, a voice coil and a surround. The diaphragm is secured to the frame by the surround.

In a first aspect of the invention the surround is a single, large, semi-circular corrugation constructed from compressed neoprene foam rubber.

In a second aspect of the invention the surround has a plurality of radially distributed, relatively less-compressed areas.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is an elevation in cross-section of an electron-dynamic acoustical transducer with a first surround that is formed according to the first embodiment.

FIG. 2 is an enlarged, elevation in cross-section of the first surround of FIG. 1.

FIG. 3 is an enlarged, elevation in cross-section of s a second surround that is formed according to the second embodiment.

FIG. 4 is an enlarged, elevation in cross-section of a third surround that is formed according to the third embodiment.

### DESCRIPTION OF THE PREFERRED EMBODIMENT

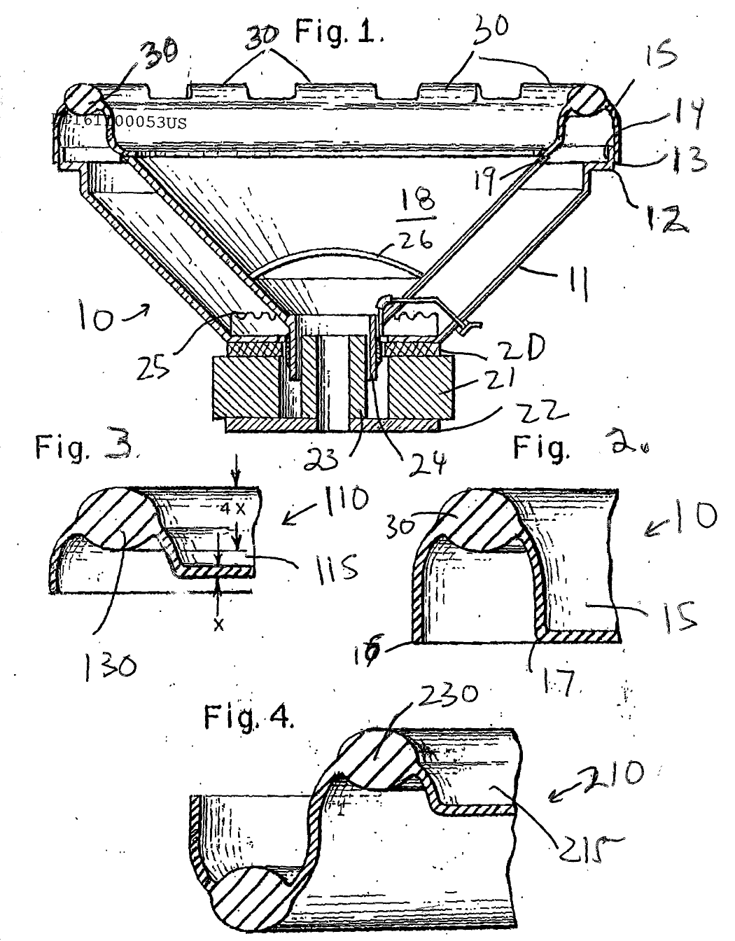

Referring to FIG. 1 a first loudspeaker 10 includes a loudspeaker frame 11 having an outer mounting flange 12. The outer mounting flange 12 includes an outer edge 13 and an inner edge 14. A first surround 15 has an outer periphery 16 and an inner periphery 17. The outer periphery 16 is attached to the mounting flange 12. The inner periphery 17 of the first surround 15 is attached to a diaphragm 18 at its outer periphery 19. The first surround 15 is attached to the mounting flange 12 and the diaphragm 18 by conventional means in the industry such as the application of adhesives.

Still referring to FIG. 1 the first loudspeaker 10 also includes a top plate 20, a magnet 21, a back plate 22, a pole piece 23 and a voice coil 24 and a spider 25. A magnetic gap is created between the inner edge of the top plate 20 and the pole piece 23. A dust cap 26 prevents foreign particles from entering the gap area. Wiring is also provided. The surround 15 is shown attached at its first outer periphery to the outer periphery of the mounting flange 12 of the frame 11, instead of inner periphery. A second inner periphery of the surround 15 is attached to the diaphragm 18 at its outer periphery.

Referring to FIG. 1 in conjunction with FIG. 2 the first surround 15 is U-shaped. The first surround 15 is formed from a single, large, semi-circular corrugation and is constructed by compressing neoprene foam rubber. The first surround 15 has a plurality of radially distributed, relatively less-compressed areas 30. One purpose of the first surround 15 is to help keep the diaphragm 18 centered and to provide a portion of the restoring force that keeps the voice coil 24 in the gap defined between the pole piece 23 and the top plate 20 of the first loudspeaker 10. The first surround 15 provides a damped termination for the edge of the diaphragm 18. The thickness of the first surround 15 can greatly alter the response of the first loudspeaker 10.

Referring to FIG. 1 in conjunction with FIG. 3 a second loudspeaker 110 includes a second surround 115. The second surround 115 includes a single, large, semi-circular corrugation constructed from compressed neoprene foam rubber. The second surround 115 is semi-circular in shape. The second surround 115 is formed from a single, large, semi-circular corrugation and is constructed by compressing neoprene foam rubber. The second surround 115 has a plurality of radially distributed, relatively less-ompressed areas 130. One purpose of the second surround 115 is to help keep the diaphragm 18 centered and to provide a portion of the restoring force that keeps the voice coil 24 in the gap defined between the pole piece 23 and the top plate 20 of the second loudspeaker 110. The second surround 115 provides a damped termination for the edge of the diaphragm 18. The thickness of the second surround 115 can greatly alter the response of the second loudspeaker 110.

Referring to FIG. 1 in conjunction with FIG. 4 a third loudspeaker 210 includes a third surround 215. The third surround 215 includes a single, large, semi-circular corrugation constructed from compressed neoprene foam rubber. The third surround 215 is S-shaped. The third surround 215 has a plurality of radially distributed, relatively less-compressed areas 230. One purpose of the third surround 215 is to help keep the diaphragm 18 centered and to provide a portion of the restoring force that keeps the voice coil 24 in the gap defined between the pole piece 23 and the top plate 20 of the third loudspeaker 210. The third surround 215 provides a damped termination for the edge of the diaphragm 18. The thickness of the third surround 215 can greatly alter the response of the third loudspeaker 210.

Referring to FIG. 3 in conjunction with FIG. 1, FIG. 2 and FIG. 4 the thicknesses (4×) of the radially distributed, relatively less-compressed areas 30, 130 and 230 are four times the thickness (×) of the relatively more-compressed area of the remaining areas. The densities of the radially distributed, relatively less-compressed areas 30, 130 and 230 are one-fourth the density of the relatively more-compressed area of the remaining areas. Other ratios between the thicknesses of the radially distributed, relatively less-compressed areas 30, 130 and 230 and the thickness (×) of the relatively more-compressed area of the remaining areas may be used. The densities of the radially distributed, relatively less-compressed areas 30, 130 and 230 are the reciprocal (1/ratio) the density of the relatively more-compressed area of the remaining areas. These radially distributed, relatively less-compressed areas 30, 130 and 230 provide increased flexibility in a direction which is orthogonal to the diaphragm 18 without losing any rigidity in any direction within the plane of the diaphragm 18 because no material has been removed from the compressed neoprene foam rubber as in the slotted surround which U.S. Pat. No. 4,433,214 teaches.

While this invention has been particularly shown and described with references to preferred embodiments thereof, it will be understood by those skilled in the art that various changes in form and details may be made therein without departing from the spirit and scope of the invention as defined by the appended claims

It should be noted that the sketches are not drawn to scale and that distance of and between the figures are not to be considered significant.

Accordingly it is intended that the foregoing disclosure and showing made in the drawing shall be considered only as an illustration of the principle of the present invention.

What is claimed is:

1. A surround for use in an electron-dynamic acoustical transducer including a frame, a diaphragm and a voice coil, said surround comprising a single, large, semi-circular corrugation being constructed from compressed neoprene foam rubber and being secured to the frame by the surround whereby said surround has a plurality of radially distributed, relatively less-compressed areas.
